(19) United States
(12) Patent Application Publication
(10) Pub. No.: US 2011/0046827 A1
(43) Pub. Date: Feb. 24, 2011

(54) APPARATUS AND METHOD FOR CONTROLLING SPEED IN AUTOMATIC TRAIN OPERATION

(75) Inventors: Young Hwan Yoon, Anyang (KR); Yung Bang, Seoul (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LS INDUSTRIAL SYSTEMS CO., LTD.

(21) Appl. No.: 12/856,528

(22) Filed: Aug. 13, 2010

(30) Foreign Application Priority Data
Aug. 24, 2009 (KR) 10-2009-0078059

(51) Int. Cl. G05D 1/00

(52) U.S. Cl. 701/20

(57) ABSTRACT

The present disclosure relates to an apparatus and method for controlling speed in an automatic train operation, capable of estimating and controlling a speed at which a train should run at each position where the train will run in order to satisfy a restrictive speed profile and to make passengers comfortable by observing acceleration limit and jerk limit in case of accelerating or decelerating the train.

Pursuant to 35 U.S.C. §119 (a), this application claims the benefit of earlier filing date and right of priority to Korean Patent Application No. 10-2009-0078059, filed on Aug. 24, 2009, the contents of which are hereby incorporated by reference in their entirety.

### BACKGROUND OF THE DISCLOSURE

### Field

The present disclosure relates to an apparatus and method for controlling speed in an automatic train operation.

More particularly, the present disclosure relates to an apparatus and method for controlling speed in an automatic train operation, capable of estimating and controlling a speed at which a train should run at each position where the train will run in order to satisfy a restrictive speed profile and to make passengers comfortable by observing acceleration limit and jerk limit in case of accelerating or decelerating the train.

### BACKGROUND

Signal control equipment in the railroad field is constructed of a technology of a variety of signal apparatuses and technologies of control systems, which are used to prevent accidents from occurring, promote a safe train operation and enhance efficiency of train operation when a train is running.

The signal control equipment is divided into train path control equipment such as a track circuit, an interlocking device, a switch device and a centralized traffic control, equipment for controlling gap between trains such as a block system and an automatic train stop, and equipment used for the purpose of an automatic train control, an automatic train operation, other operation securities and information.

The automatic train operation in the signal control equipment is used to enhance operation efficiency of the train by automatically performing functions such as acceleration, deceleration and stop of the train.

The automatic train operation is known to include a method in which a running schedule is planned in advance in harmonization with given running condition and railroad and a method in which a variety of speed patterns when running a predetermined distance are stored in advance and a running schedule is set by selecting a speed pattern suitable to a condition. In the method in which a running schedule is planned in advance in harmonization with given running condition and railroad, the train is operated by determining speed control pattern of the train in advance at each position with respect to a specific running section, and making the speed of train follow the determined speed control pattern.

However, when running state of the train is largely out of the running schedule due to the delay of preceding train or the like, it is not easy to correct the schedule determined previously, whereby an operational delay occurs and it is not easy to follow the delay time occurred. Further, when the train is out of running schedule due to disturbance or the like, it is not easy to correct the schedule. In this case, when excessively following the schedule determined previously, it is not easy to accomplish goals such as energy saving and comfortable ride that are applied on the running schedule. Further, it is not easy to flexibly deal with need to correct the running schedule such as the change of railroad condition and railroad state.

Further, in the method in which a variety of speed patterns when running a predetermined distance are stored in advance and a running schedule is set by selecting a speed pattern suitable to a condition, it is possible to plan an entire running schedule to a target point by continuously combining a plurality of speed patterns. Further, a condition instruction apparatus compares a current position of the train with route information input previously. And, when the train approaches the speed restrictive section, the condition instruction apparatus detects it and reviews various conditions such as the level of margin in diagram and the level at which the train approaches a preceding train. Thereafter, the condition instruction apparatus selects a suitable pattern and makes an instruction.

However, it may not be clear how to change the speed pattern of the train and to operate it. That is, it is not easy to guarantee that the condition instruction apparatus finds the optimum pattern in a given condition when the condition to determine the optimum state is not clear. Further, it is not easy to obtain satisfactory result for every case since it is not possible to have every speed pattern.

Further, the registered Korean patent No. 10-435983 discloses that a target speed is received from a track circuit, a jerk profile used to reach the target speed from a current speed while observing an acceleration limit and a jerk limit is obtained, an acceleration profile and a speed profile are obtained by integrating the jerk profile, and a train follows the speed profile obtained.

However, since a time based profile is used in the registered Korean patent No. 10-435983, a following control is not easily performed so that it is not easy to correct a position error when a running state is out of a running schedule. Especially, when a speed of the train should satisfy a speed limit value at a specific position, which can be a trouble when the train is in the state of deceleration operation, it is not easy to correct an error occurring at the position in which the speed limit is satisfied when following the profile according to time lapse. That is, an area of the lower part of a speed-time graph indicates the moved distance of the train. When an error occurs between a target profile and an actual running record in the case of following the speed profile, there may resultantly occur an error of the area of the lower part of the speed-time graph. Further, when there occurs a problem in the following even temporarily, it is not possible to recover it.

Therefore, there is a limit in using the time based profile even when stopping the train automatically.

Further, the registered Korean patent simply suggests only a general type of profile calculation method to reach a target speed from a current speed. Further, it suggests a profile that is divided into three sections, a predetermined jerk—a predetermined acceleration—a predetermined jerk. However, since a variety of patterns may occur when a complicated limit speed profile is given, it is not easy to respond to it with the profile calculation pattern described above only. That is, it is not easy to respond to an arbitrary restrictive speed profile dependent on position with the method described above, whereby there occurs a limit in the flexibility of automatic train operation.

### SUMMARY

Therefore, it is an object of the present disclosure to provide an apparatus and method for controlling speed in an automatic train operation, capable of drawing a position based speed profile that can draw the optimum running performance from a restrictive speed profile in each section while observing an acceleration limit and a jerk limit for the sake of comfortable ride of passengers when the restrictive speed profile in each section drawn in consideration of a variety of conditions including railroad situation, gap between trains and diagram change is received from a ground signal system, and obtaining desired running performance and stopping performance in the automatic train operation by controlling the train so as to follow the drawn speed profile.

Technical objects of the present disclosure are not limited to the technical objects described above, and other technical objects that are not mentioned will be clearly understood by those skilled in the field with reference to the description below.

In one general aspect of the present disclosure, a speed control apparatus in an automatic train operation, includes: an automatic operation speed profile calculator that calculates a target speed at each position where a train is automatically operated using a restrictive speed profile inputted from a restrictive speed profile provider, and provides a position-speed profile with which the train is automatically operated; a speed/position calculator that calculates current position and running speed of the train; a target speed searching unit that searches for a target speed at a current position of the train calculated by the speed/position calculator from a position-speed profile provided by the automatic operation speed profile calculator; a subtractor that subtracts the target speed searched by the target speed searching unit from the running speed of the train calculated by the speed/position calculator and detects a speed error; and a propulsion/brake calculator that generates propulsion or brake instruction of the train according to the speed error detected by the subtractor,

wherein the automatic operation speed profile calculator extracts an acceleration target point to be reached by accelerating the train, a constant speed target point to be reached by running the train at a constant speed and a deceleration target point to be reached by decelerating the train from the restrictive speed profile, divides sections between a starting position, the acceleration target point, the constant speed target point and the deceleration target point of the train, and calculates a position-speed profile in each section.

In some exemplary embodiments, the restrictive speed profile may include information on a restrictive speed at which the train will run in each section.

In some exemplary embodiments, a calculation of the position-speed profile may be performed in that a time-speed profile is calculated in each section, a time-position profile is calculated using the calculated time-speed profile and then a position-speed profile is calculated using the time-speed profile and the time-position profile.

In some exemplary embodiments, the speed control apparatus may further include a database to store the position-speed profile provided by the automatic operation speed profile calculator, wherein the target speed searching unit searches for a target speed from the database.

In some exemplary embodiments, the restrictive speed profile provider may be installed in a ground system and wirelessly transmits the restrictive speed profile to an on-board system, and the automatic operation speed profile calculator is installed in an on-board system, calculates a position-speed profile using the restrictive speed profile that is wirelessly transmitted by the restrictive speed profile provider and stores the position-speed profile in the database.

In some exemplary embodiments, the restrict speed profile provider and the automatic operation speed profile calculator may be installed in the ground system, transmit the position-speed profile provided by the automatic operation speed profile calculator to the on-board system and store the profile in the database.

In some exemplary embodiments, the restrictive speed profile provider and the automatic operation speed profile calculator may be installed in the on-board system.

In another general aspect of the present disclosure, a speed control method in an automatic train operation, includes: providing, by an automatic operation speed profile calculator, a position-speed profile that is a target speed at each position where a train is automatically operated using an restrictive speed profile inputted from a restrictive speed profile provider; calculating a current position and a running speed of the train by a speed/position calculator; searching for a target speed at the current position of the train from the position-speed profile by a target speed searching unit; detecting a speed error by subtracting the searched target speed from the running speed of the train; and generating a propulsion or brake instruction of the train according to the detected speed error.

In some exemplary embodiments, providing, by an automatic operation speed profile calculator, a position-speed profile that is a target speed at each position where a train is automatically operated using an restrictive speed profile inputted from a restrictive speed profile provider may include extracting an acceleration target point to be reached by accelerating the train, a constant speed target point to be reached by running the train at a constant speed and a deceleration target point to be reached by decelerating the train from the restrictive speed profile; dividing sections between a starting position, the extracted acceleration target point, the extracted constant speed target point and the extracted deceleration target point of the train; and calculating a speed of the train to be run at each position of the train in each section divided and providing the position-speed profile.

In some exemplary embodiments, providing, by an automatic operation speed profile calculator, a position-speed profile that is a target speed at each position where a train is automatically operated using an restrictive speed profile inputted from a restrictive speed profile provider may include calculating the time-speed profile in each section divided; calculating a time-position profile using the calculated time-speed profile; and calculating a position-speed profile by detecting a speed of the train to be run at each position from the time-speed profile and the time-position profile, and providing the calculated position-speed profile.

### EFFECTS

According to an apparatus and method for controlling a speed in an automatic train operation of the present disclosure, it is possible to plan the optimum operation schedule of a train by calculating running schedule speed profile of the automatic train operation based on an acceleration limit and a jerk limit that are values given in consideration of comfortable ride and performance of the train, wherein the acceleration limit and jerk limit used to obtain the profile can be set with some margin in consideration of performance of a controller on the basis of values given according to a comfortable ride and performance of the train.

Further, the train can stop at an exact position while observing a limit speed of each position by generating an automatic operation speed profile based on the distance (position) and operating it using a control reference speed based on the distance (position).

Further, it is possible to plan and correct an automatic operation running schedule flexibly correspondingly to an arbitrary limit speed profile during the train is running.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description, serve to explain the principle of the disclosure. In the drawings:

FIG. 1 is a view showing a construction of an automatic train operation system;

FIG. 2 is a view showing a construction of a speed control apparatus according to a preferred embodiment of the present disclosure;

FIG. 3 is a view showing an example of a restrictive speed profile;

FIG. 4 is a view explaining an operation to set an acceleration target point, a restrictive target point and a constant speed target point in a restrictive speed profile;

FIGS. 5˜8 are views showing an example of a basic pattern used to calculate a profile between a starting point and a plurality of target points;

FIG. 9 is a view showing an example of a jerk limit, an acceleration limit and a position-speed profile at a section a restrictive speed profile, 300 m˜650 m;

FIG. 10 is a view showing a time-position profile at a section of a restrictive speed profile, 300 m˜650 m;

FIG. 11 is a view showing a position-speed profile at a section of a restrictive speed profile, 300 m˜650 m;

FIG. 12 is a view showing an example to calculate a position-speed profile according to the present disclosure;

FIG. 13 is a view showing an example of an automatic operation position-speed profile of the present disclosure with respect to a restrictive speed profile shown in FIG. 3; and

FIGS. 14a˜14c are views explaining an operation to change an automatic operation position-speed profile when a restrictive speed profile is changed according to the present disclosure.

### DETAILED DESCRIPTION

The detailed description to be described below is nothing but an example and an exemplary embodiment of the present disclosure. Further, the principle and concept of the present disclosure are provided for the purpose of explaining the present disclosure in the most available and easy manner.

Accordingly, unnecessarily detailed structures that are beyond a basic understanding of the present disclosure are not provided and various forms that can be embodied in the substance of the present disclosure by those skilled in the art are illustrated with reference to the drawings.

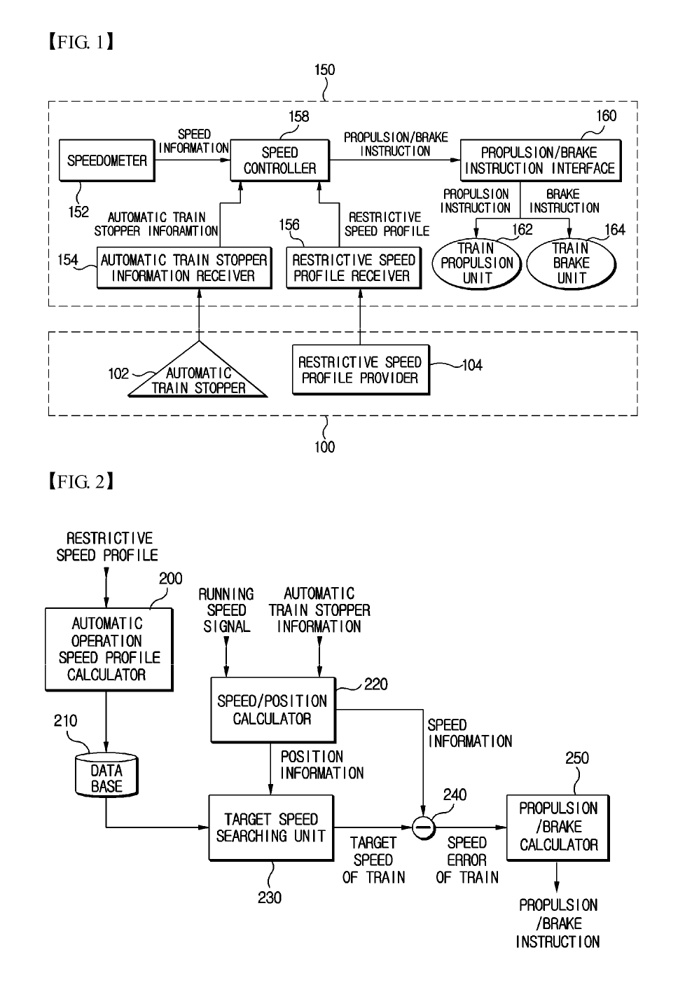

FIG. 1 is a view showing a construction of an automatic train operation system. Here, the numeral 100 denotes a ground system installed adjacently to railroad on which a train runs. The ground system 100 includes an automatic train stop transmitter 102 and a restrictive speed profile provider 104.

The automatic train stop transmitter 102 wirelessly transmits the automatic train stop transmitter information including a current position of the train or the like when the train passes through a position where the automatic train stop transmitter 102 is installed.

The restrictive speed profile provider 104 calculates the restrictive speed profile in each section and wirelessly transmits it. For example, the restrictive speed profile in each section includes information on speed and running distance in each section, at which the train should run in each section according to the distance to the preceding train, the railroad condition and so on.

The numeral 150 denotes an on-board system installed in the train. The on-board system 150 includes a speedometer 152, an automatic train stop transmitter information receiver 154, a restrictive speed profile receiver 156, a speed controller 158, a propulsion/brake instruction interface 160, a train propulsion unit 162, and a train brake unit 164.

The speedometer 152 detects a running speed of the train and generates a running speed signal.

The automatic train stop transmitter information receiver 154 receives automatic train stop transmitter information that is transmitted by the automatic train stop transmitter 102 of the ground system 100.

The restrictive speed profile receiver 156 receives a restrictive speed profile that is transmitted by the restrictive speed profile provider 104 of the ground system 100.

The speed controller 158 estimates a running speed of the train according to a running speed signal generated by the speedometer 152, automatic train stop transmitter information that is received by the automatic train stop transmitter information receiver 154, and a restrictive speed profile that is received by the restrictive speed profile receiver 156, and generates a propulsion/brake instruction according to the estimated running speed.

The propulsion/brake instruction interface 160 interfaces a propulsion/brake instruction generated by the speed controller 158.

The train propulsion unit 162 propels the train according the propulsion instruction that is interfaced by the propulsion/brake instruction interface 160.

The train brake unit 164 brakes the train according to the brake instruction that is interfaced by the propulsion/brake instruction interface 160.

FIG. 2 is a view showing a construction of a speed controller 158 in an automatic train operation system of FIG. 1 according to a preferred embodiment of the present disclosure. Referring to FIG. 2, the speed controller 158 includes an automatic operation speed profile calculator 200, a database 210, a speed/position calculator 220, a target speed searching unit 230, a subtractor 240 and a propulsion/brake calculator 250.

The automatic operation speed profile calculator 200 calculates an automatic operation speed profile with which the train is automatically operated on the basis of distance according to a restrictive speed profile in each section that is inputted from the restrictive speed profile provider 104.

The database 210 stores the automatic operation speed profile calculated by the automatic operation speed profile calculator 200.

The speed/position calculator 220 calculates current position information and current speed information of the train using a running speed signal output from the speedometer 152 and automatic train stop transmitter information received by the automatic train stop transmitter information receiver 154.

The target speed searching unit 230 searches a target speed at which the train should run at the current position from the database 210, the current position being calculated by the speed/position calculator 220.

The subtractor 240 calculates a speed error the train by subtracting the target speed searched by the target speed searching unit 230 from the current speed of the train calculated by the speed/position calculator 220.

The propulsion/brake calculator 250 calculates propulsion or brake of the train according to the speed error of the train calculated by the subtractor 240, generates a propulsion/brake instruction of the train according to the calculation result and outputs the instruction to the propulsion/brake instruction interface 160.

According to the present disclosure having such a construction, when the train runs on the railroad, the speedometer 152 detects the running speed of the train and generates a running speed signal, and the running speed signal generated is inputted to the speed/position calculator 220 of the speed controller 158.

Further, when the train reaches a position where the automatic train stop transmitter 102 of the ground system 100 is installed, the automatic train stop transmitter information receiver 154 receives automatic train stop transmitter information transmitted by the automatic train stop transmitter 102, that is, automatic train stop transmitter information including information on a position where the train is currently running, and inputs it to the speed/position calculator 220 of the speed controller 158.

Further, when the ground system 100 calculates a new restrictive speed profile in each section with respect to the same train and the restrictive speed profile provider 104 transmits the newly calculated restrictive speed profile in each section to the on-board system 150 through a medium such as wireless communication, the restrictive speed profile receiver 156 receives the new restrictive speed profile in each section and inputs the profile to the automatic operation speed profile calculator 200 of the speed controller 158.

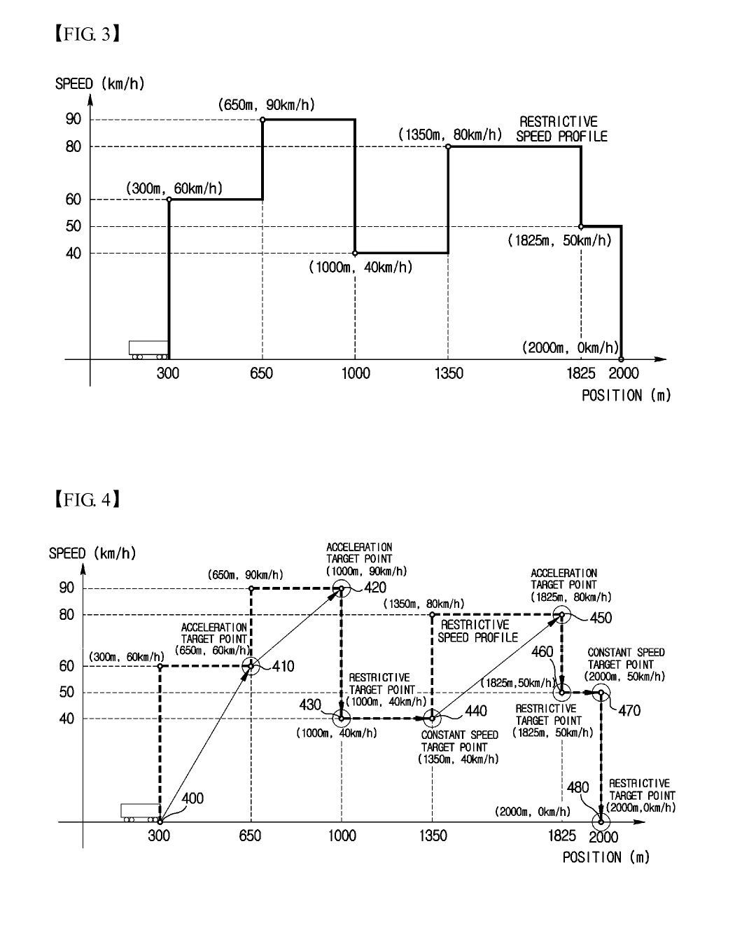

The restrictive speed profile in each section includes restrictive speed information in each section according to the position of the train. For example, it includes restrictive speed information instructing the train to run at a speed of 60 km/h or less between 300 m to 650 m, at a speed of 90 km/h or less between 650 m to 1000 m, at a speed of 40 km/h or less between 1000 m to 1350 m, at a speed of 80 km/h or less between 1350 m to 1825 m and at a speed of 50 km/h or less between 1825 m to 2000 m, as shown in FIG. 3.

Further, when the train does not receive a new restrictive speed profile in each section while running up to the point 2000 m, the train should stop before the point 2000 m.

When the restrictive speed profile in each section shown in FIG. 3 is inputted from the restrictive speed profile receiver 156, the automatic operation speed profile calculator 200 calculates an automatic operation speed profile that is a target speed at which the train should run at each position of the train in consideration of given acceleration limit and jerk limit.

When the automatic operation speed profile of each position of the train is calculated, the automatic operation speed profile calculator 200 stores the calculated automatic operation speed profile of each position of the train in the database 210.

In this state, the speed/position calculator 220 generates position information indicating the current position of the train and speed information indicating the current running speed of the train, using the running speed signal input from the speedometer 152 and automatic train stop transmitter information input from the automatic train stop transmitter information receiver 154.

That is, the speed/position calculator 220 identifies a current position of the train from the automatic train stop transmitter information input from the automatic train stop transmitter information receiver 154, detects a current position at which the train runs from the indentified current position using a running speed signal input from the speedometer 152 and generates it. Further, the speed/position calculator 220 generates speed information indicating the current running speed of the train using a running speed signal input from the speedometer 152.

When the speed/position calculator 220 generates current position information of the train, the target speed searching unit 230 searches for the target speed at which the train should run at the current position by searching the database 210, and outputs the searched target speed to the subtractor 240.

Then, the subtractor 240 calculates a speed error of the train by subtracting the target speed searched by the target speed searching unit 230 from the current running speed of the train generated by the speed/position calculator 220. The propulsion/brake calculator 250 makes a calculation using the calculated speed error to determine whether the train is to be propelled or braked and generates a propulsion/brake instruction.

The propulsion/brake instruction generated by the propulsion/brake calculator 250 is transferred to a train propulsion unit 160 and a train brake unit 164 through the propulsion/brake instruction interface 160, and propels or brakes the train.

Therefore, the train runs while following each speed for the current positions of the train stored in the database 210.

In the present disclosure, an operation will be described in detail in that the automatic operation speed profile calculator 200 receives such restrictive speed profile in each section as shown in FIG. 3, for example and calculates an automatic operation speed profile that is a target speed at which the train should run at each position of the train.

First, the automatic operation speed profile calculator 200 receives such restrictive speed profile in each section as shown in FIG. 3, and sequentially connects acceleration target points 410, 420 and 450 to be reached by running the train in the acceleration operation, constant speed target points 440 and 470 to be reached by running the train in the constant speed operation, and restrictive target points 430, 460 and 480 to be reached by running the train in the deceleration operation from the starting position 400 of the train at a point 300 m to a point 2000 m of the restrictive speed profile in each section and extracts them, as shown in FIG. 4.

That is, the automatic operation speed profile calculator 200 sequentially connects an acceleration target point 410 at a point 650 m, an acceleration target point 420 and a restrictive target point 430 at a point 1000 m, a constant speed target point 440 at a point 1350 m, an acceleration target point 450 at a point 1825 m, a restrictive target point 460 at a point 1825 m, a constant speed target point 470 at a point 2000 m, and a restrictive target point 480 at a point 2000 m and extracts them.

When the starting position 400 and a plurality of target points 410 to 480 are extracted, the automatic operation speed profile calculator 200 calculates the speed profile for the entire section using the speed profiles between the starting position 400 and the plurality of target points 410 to 480.

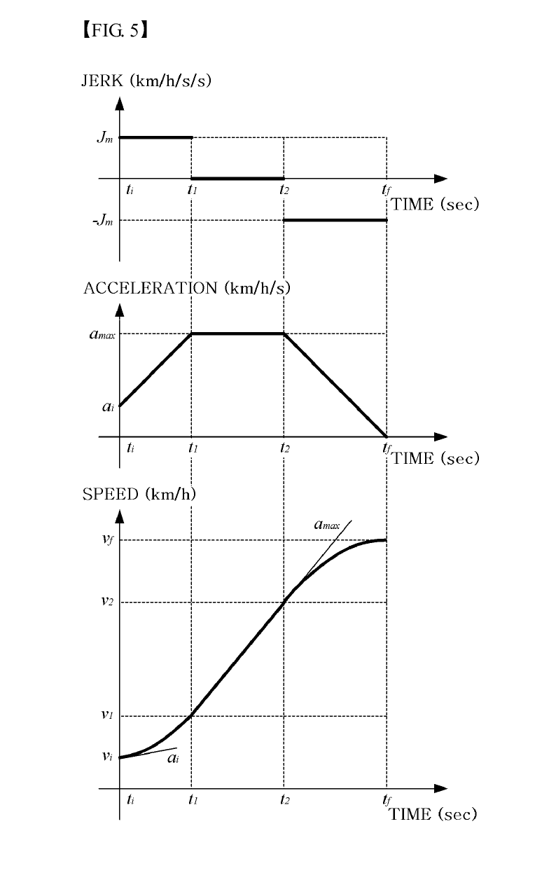

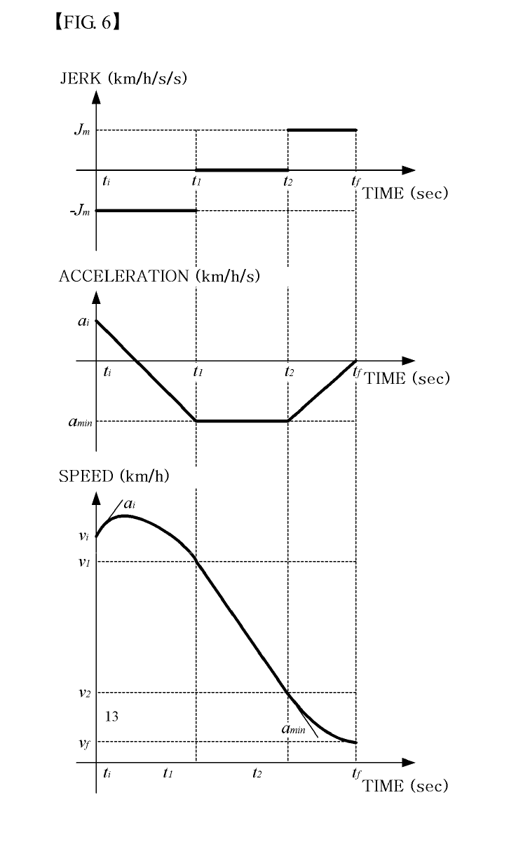

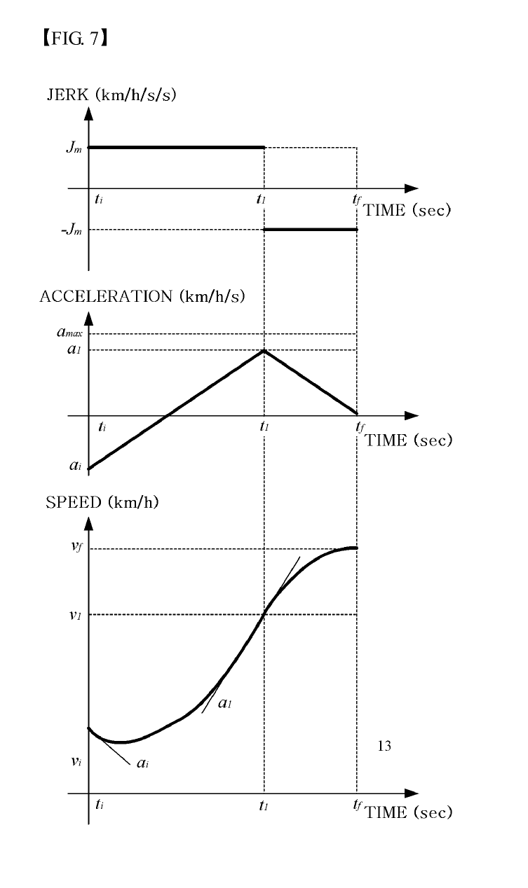

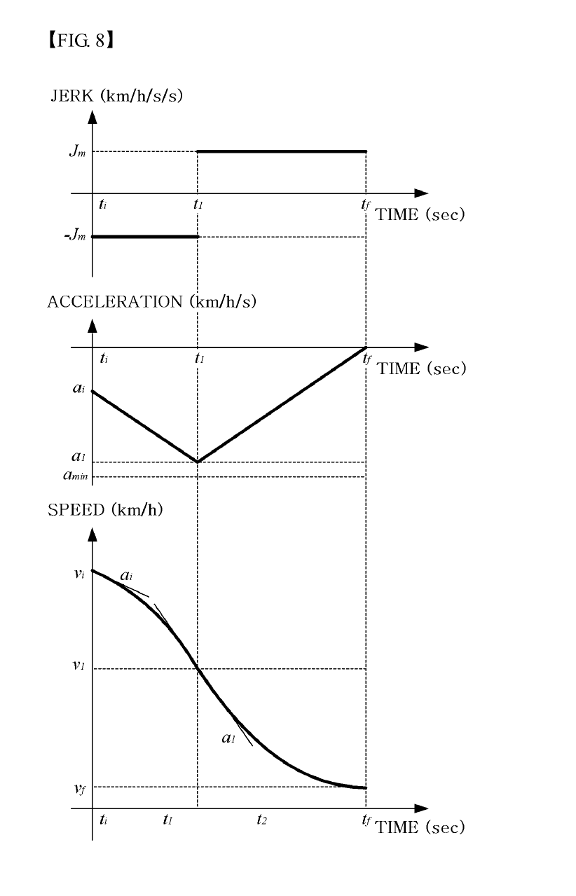

When the speed profiles between the starting position 400 and the plurality of target points 410 to 480 are calculated, basic speed patterns shown in FIGS. 5 to 8 are used, for example.

That is, in the case that the pattern is directed to the acceleration target points 410, 420 and 450, a basic speed pattern of FIG. 5 with acceleration increase→uniform acceleration→acceleration decrease or a basic speed pattern of FIG. 7 with acceleration increase→acceleration decrease is used.

Further, in the case that the pattern is directed to the restrictive target points 430, 460 and 480, a basic speed pattern of FIG. 6 with acceleration decrease→uniform acceleration→acceleration increase or a basic speed pattern of FIG. 8 with acceleration decrease→acceleration increase is used.

A separate acceleration pattern or deceleration pattern is not needed with respect to constant speed target points 440 and 470 since it is possible to run the train at a fixed speed at those points.

A basic speed pattern when an initial state of the train (initial position lᵢ, initial speed vᵢ and initial acceleration aᵢ) and a state of the train at a target point (target position l_{tgt}, target speed v_{f} and target acceleration a_{f}=0), and an acceleration limit (maximum at acceleration aₘₐₓ and minimum at deceleration aₘᵢₙ) and a jerk limit (maximum Jₘ and minimum −Jₘ) are given is drawn in the following order.

First, in the case of acceleration target points 410, 420 and 450, the profile at the section tᵢ˜t₁, section t₁˜t₂ and section t₂˜t_{f} in the first basic pattern shows a shape of acceleration increase (maximum jerk), uniform acceleration (jerk 0) and acceleration decrease (minimum jerk), respectively. In order to determine expression of the pattern, it is needed to obtain values of boundary time t₁, t₂ and t_{f}.

Further, the acceleration profile can be obtained by integrating the jerk profile and the speed profile can be obtained by integrating the acceleration profile. When the initial time is set as 0 (tᵢ=0), acceleration profile a(t) and speed profile v(t) at the entire section can be indicated as expressions 1 and 2 below, respectively.

$$\begin{matrix}a ( t ) = \{ \begin{matrix}{a}_{i} + {J}_{m} \cdot t & where 0 \leq t \leq {t}_{1} \\ {a}_{max} & where {t}_{1} \leq t \leq {t}_{2} \\ - {J}_{m} ( t - {t}_{f} ) & where {t}_{2} \leq t \leq {t}_{f}\end{matrix} & Expression 1 \\ v ( t ) = \{ \begin{matrix}{v}_{i} + {a}_{i} \cdot t + 0.5 \cdot {J}_{m} \cdot {t}^{2} & where 0 \leq t \leq {t}_{1} \\ {v}_{1} \vert {a}_{max} \cdot t & where {t}_{1} \leq t \leq {t}_{2} \\ {v}_{2} + {J}_{m} \cdot {t}_{f} \cdot t - 0.5 \cdot {J}_{m} \cdot t & where {t}_{2} \leq t \leq {t}_{f}\end{matrix} & Expression 2\end{matrix}$$

The values of t₁, t₂ and t_{f} can be obtained when using the boundary condition in the case of t=t₁, t=t₂ and t=t_{f} in the acceleration profile a(t) of the expression 1 and the speed profile v(t) of the expression 2.

At this time, in the case of t₁<t₂, there exists the uniform acceleration section since the distance up to the acceleration target points 410, 420 and 450 is long sufficient, and therefore a basic pattern with acceleration increase→uniform acceleration→acceleration decrease shown in FIG. 5 is taken.

Further, in the case of t₁≧t₂, there is not existed the uniform acceleration section since the distance up to the acceleration target points 410, 420 and 450 is short, and therefore a basic pattern with acceleration increase→acceleration decrease shown in FIG. 7 is taken.

Further, in the case of the restrictive target points 430, 460 and 480, it is possible to determine variables of a basic pattern and expression according to the restrictive target point through the same process as the acceleration target points 410, 420 and 450.

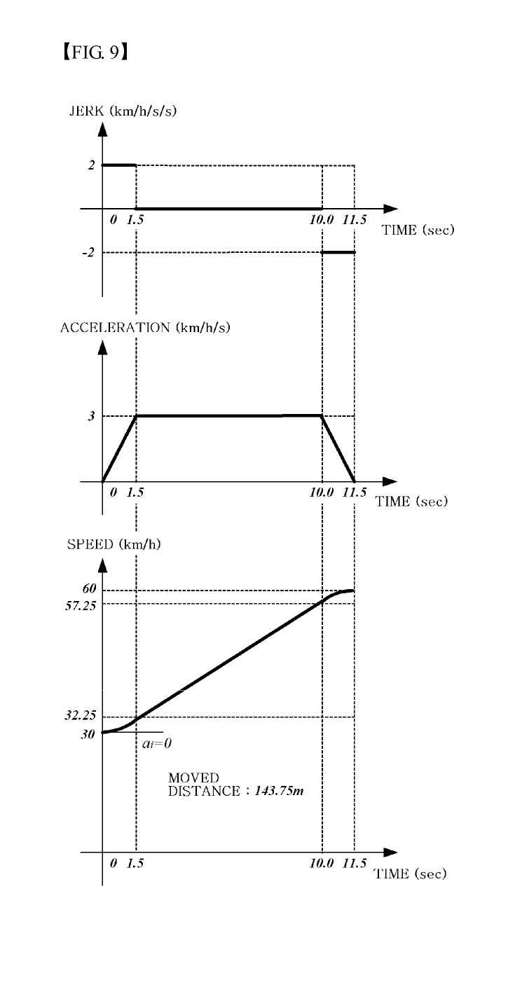

FIG. 9 illustrates an example in which a basic pattern is applied with respect to the first acceleration target point 410 at the section of 300 m˜650 m of the restrictive speed profile in each section.

Here, it is assumed that given jerk limit is Jₘ=2 km/h/s/s, and acceleration limit is aₘₐₓ=3 km/h/s to the maximum. Further, it is assumed that an initial acceleration of the train is 0 km/h/s, an initial speed of it is 30 km/h, and an initial position of it is 300 m.

When drawing variables of pattern according to the method of the present disclosure described above, it is possible to obtain a profile with which the train reaches 60 km/h of the target speed after 11.5 seconds as shown in FIG. 9.

Values of the boundary time t₁, t₂ and t_{f} are 1.5 seconds, 10.0 seconds and 11.5 seconds, respectively, and values of the train speed at these times are 32.25 km/h, 57.25 km/h and 60 km/h, respectively.

The moved distance of the train can be obtained by integrating the speed obtained as described above, and the moved distance of the train up to time t1 taken to reach the target speed v1 at the pattern shown in FIG. 9 is 143.75 m.

Since the distance 143.75 m is shorter than the distance of 350 m that is between the starting position 400 to the acceleration target point 410, the automatic operation speed profile starts from the point 300 m, reaches 60 km/h, the target speed of the train at the point 443.75 m, and then runs at a constant speed until the acceleration target point 410.

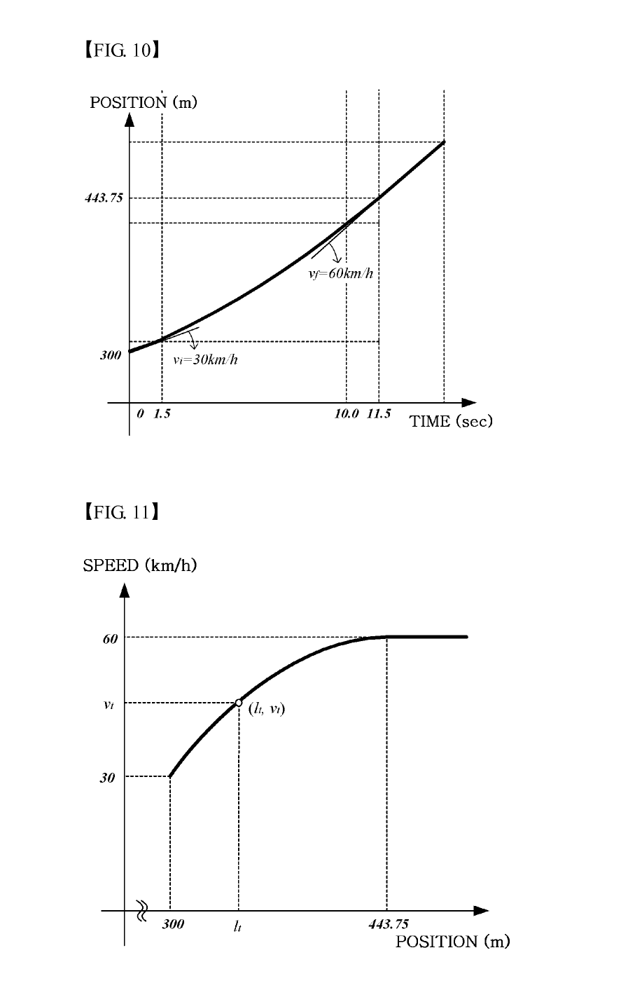

When the position of the train at each time is obtained by integrating the speed in the time-speed profile shown in FIG. 9, it is possible to draw a time-position profile shown in FIG. 10. Further, when the obtained time-speed profile and the time-position profile are combined using time as a parameter, it is possible to draw a position-speed profile as shown in FIG. 11.

For example, when it is assumed that the speed in the time-speed profile is vₜ and the position in the time-position profile is lₜ in the case of time t in FIG. 11, it is possible to obtain a value in the position-speed profile, (lₜ, vₜ). It means that the target speed is set as vₜ at the position lₜ in the case of automatic train operation.

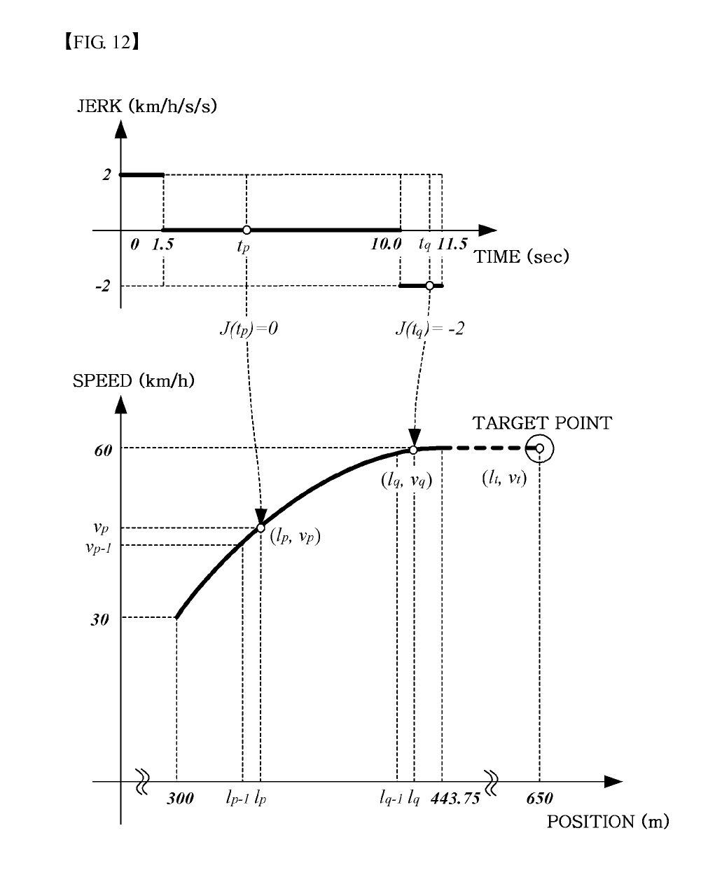

FIG. 12 suggests a method to draw a position-speed profile using a calculation in a computer or a microprocessor, and a value of the position-speed profile can be calculated through a procedure described below.

1. A time dependent jerk profile J(t) is obtained using a basic acceleration pattern, a time dependent reference jerk is obtained on the basis of the jerk profile J(t), and the reference jerk is used.

For example, as shown in FIG. 12, lₚ is obtained at time tₚ using the reference jerk J(tₚ)=0, and l_{q} is obtained at time t_{q} using the reference jerk J(t_{q})=−2.

2. Position and time at a current calculation step are lₚ=l(tₚ), tₚ=p·Δt (here, p=0, 1, 2, . . . , t₀=0, l₀=l(0)), a profile from l₀ to lₚ₋₁ that is a prior step {(lⱼ, vⱼ)|j=0, 1, 2, . . . , p−1} is in a state calculated, and position, speed and acceleration lₚ₋₁, vₚ₋₁ and aₚ₋₁ at an immediately prior state (time tₚ₋₁) are stored (initial state: l₀, v₀ and a₀).

3. In the case that the profile is directed toward the acceleration target point, a reference speed vₚ at the current position can be calculated using expression 3 below in the case of vₚ₋₁=vt, and calculated using expression 4 below in the case of vₚ₋₁<vₜ.

$$\begin{matrix}\{ \begin{matrix}{a}_{p} = 0 \\ {v}_{p} = {v}_{t} \\ {1}_{p} = {1}_{p - 1} + {v}_{t} \cdot Δ t\end{matrix} & Expression 3 \\ \{ \begin{matrix}{a}_{p} = {a}_{p - 1} + J ( {t}_{p} ) \cdot Δ t = {a}_{p - 1} + J ( p Δ t ) \cdot Δ t \\ {v}_{p} = {v}_{p - 1} + {a}_{p - 1} \cdot Δ t + 0.5 \cdot J ( {t}_{p} ) \cdot Δ {t}^{2} \\ {1}_{p} = {1}_{p - 1} + {v}_{p} \cdot Δ t\end{matrix} & Expression 4\end{matrix}$$

The expression 3 is used when the pattern is directed toward the acceleration target point and it has acceleration increase→uniform acceleration→acceleration decrease shown in FIG. 5. Even when the pattern is directed toward a deceleration target point or it does not have the uniform acceleration section, it is possible to draw an expression of v(t) obtained by integrating jerk profiles in FIGS. 6 to 8 in the same manner as the expression 3.

Here, lₚ of the expression 4 may be calculated by applying a movement average as shown in an expression 5.

$${1}_{p} = {1}_{p - 1} + \frac{{v}_{p} + {v}_{p - 1}}{2} \cdot Δ t \qquad Expression 5$$

4. The processes 1 to 3 are repeated starting from a starting point of the section used to obtain the profile until lₚ reaches the target position lₜ.

Here, although Δt is used as a fixed value, a variable value may be used for it, which is regulated according to speed of the train.

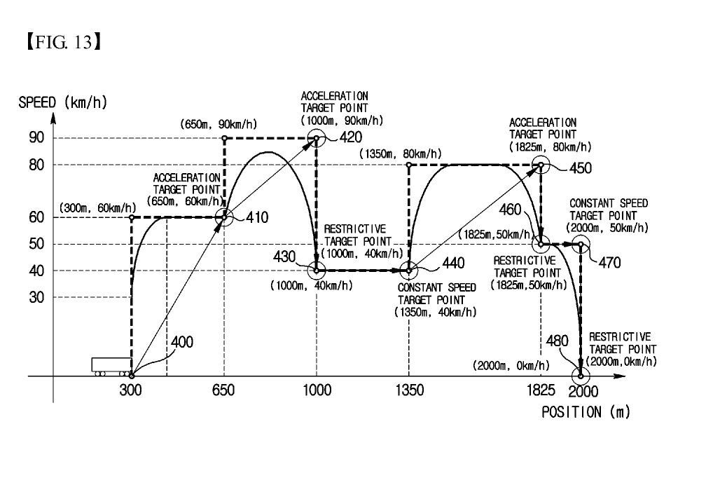

FIG. 13 is a view showing an example of an position-speed profile that the automatic operation speed profile calculator 200 obtained by repeating the processes described above at each target point with respect to the restrictive speed profile in each section shown in FIG. 3, starting from the starting position 400 until it reaches the restrictive target point 480 of the final position.

Here, a procedure to calculate the position-speed profile in the restrictive speed profile in each section from the starting position 400 of the train to the restrictive target point 480 of the final position in the forward direction will be described.

At the section of 300 m to 650 m, the position-speed profile is prepared starting from a point 300 m toward the acceleration target point 410 (650 m, 60 km/h) as suggested in the example. At the section of 650 m to 1000 m, while the position-speed profile is prepared toward the acceleration target point 420 (1000 m, 90 km/h) at the point 650 m, the target point is changed to the restrictive target point 430 (1000 m, 40 km/h) in the mean time and then the position speed profile is prepared.

Since it is possible to obtain distance needed to reach a specific target point from a current position using the basic pattern described above, brake distance needed with respect to the following restrictive target point 430 and actually remaining distance are compared in each calculation step and brake profile with respect to the restrictive target point 430 may be prepared when the brake distance and the remaining distance are identical each other.

The position-speed profile is prepared toward the constant speed target point 440 (1350 m, 40 km/h) at a constant speed at the section 1000 m to 1350 m and the position-speed profile is prepared toward the acceleration target point 450 (1350 m, 80 km/h) at the section 1350 m to 1825 m and reaches the target speed 80 km/h. After reaching the target speed, the position-speed profile is prepared at a constant speed. Further, when it is determined that brake is needed with respect to the restrictive target point 460 (1825 m, 50 km/h) in the same manner as the section 650 m to 1000 m, the position-speed profile is prepared to brake up to the restrictive target point 460 (1825 m, 50 km/h) by applying the deceleration profile pattern.

Finally, at the section 1825 m to 2000 m, the position-speed profile is prepared to brake from the time point needed to brake with respect to the restrictive target point 480 (2000 m, 0 km/h) and then a position-speed profile with which the train can stop at the restriction target point 480 (2000 m, 0 km/h).

When the automatic operation speed profile calculator 200 calculates the position-speed profile by applying the restrictive speed profile and a new restrictive speed profile is inputted in the state that the train runs according the calculated position-speed profile, a position-speed profile is calculated again by applying the new restrictive speed profile, and the train is run according to the position-speed profile calculated again.

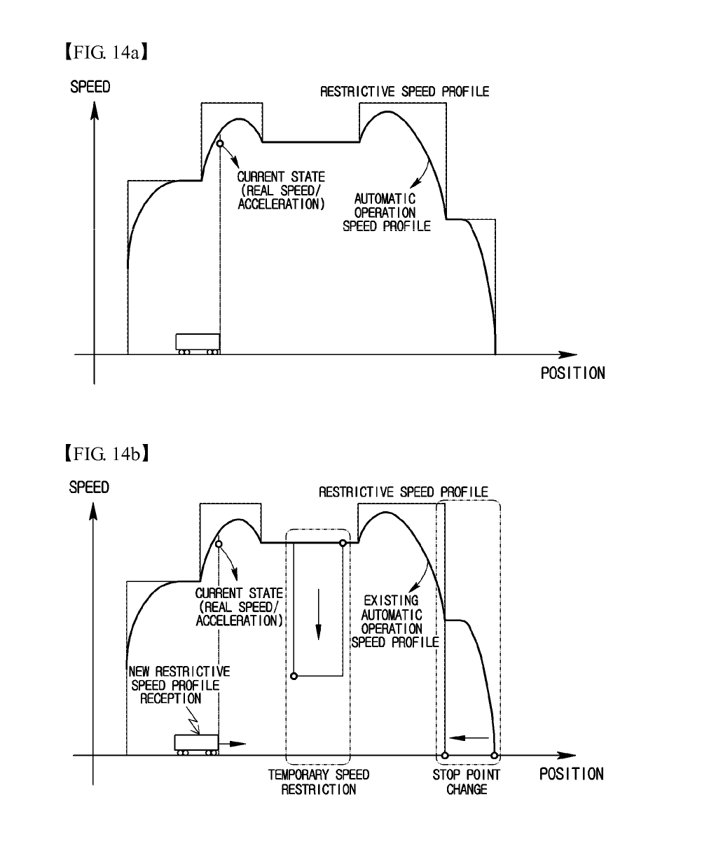

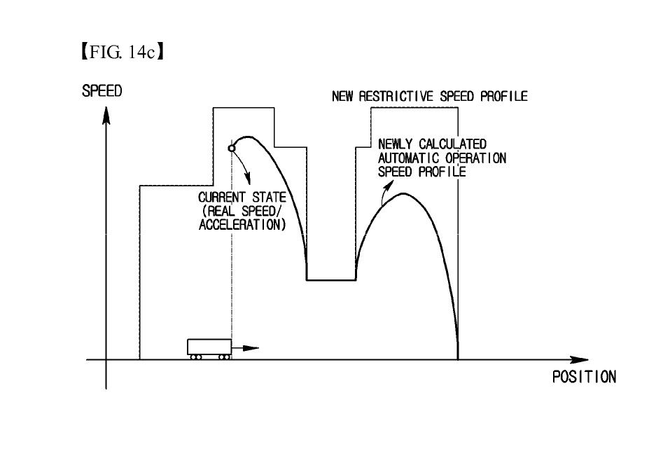

For example, when the automatic operation speed profile calculator 200 calculates the position-speed profile as shown in FIG. 14a, and a restrictive speed profile is inputted in which a running speed restriction section and a stop point are temporarily changed as shown in FIG. 14b while the train is running according to the calculated position-speed profile, the automatic operation speed profile calculator 200 applies the newly inputted restrictive speed profile to the calculated position-speed profile, so that it updates the position-speed profile with which the train is automatically operated as shown in FIG. 14c and the train is operated according to the updated position-speed profile, for example.

Meanwhile, an example in which the ground system 100 includes the restrictive speed profile provider 104 and the on-board system 150 has the automatic operation speed profile calculator 200 mounted thereon is described above.

The embodiment of the present disclosure is not limited to the above example, and a construction in which the restrictive speed profile provider 104 and the automatic operation speed profile calculator 200 are both mounted on the on-board system 150 or a construction in which the restrictive speed profile provider 104 and automatic operation speed profile calculator 200 are both mounted on the ground system 100 may be possible.

When the restrictive speed profile provider 104 and automatic operation speed profile calculator 200 are both mounted on the on-board system 150, the ground system 100 transmits information that can affect the restrictive speed of the train to the on-board system 150 whenever the information is generated.

Further, the restrictive speed profile provider 104 included in the on-board system 150 calculates the restrictive speed profile according to the information transmitted by the ground system 100 and transfers it to the automatic operation speed profile calculator 200, and the automatic operation speed profile calculator 200 calculates the position-speed profile with which the train is automatically operated according to the restrictive speed profile and stores it in the database 210.

In this construction, the kind of data to be transmitted to the on-board system 150 by the ground system 100 may become somewhat complicated, and the calculation load in the on-board system may be increased. However, since the amount of the calculation in the restrictive speed profile is much less compared with that in the position-speed profile, the calculation of the restrictive speed profile may not substantially burden the on-board system 150.

Further, when the restrictive speed profile provider 104 and automatic operation speed profile calculator 200 are both installed on the ground system 100, the restrictive speed profile provider 104 calculates the restrictive speed profile in the case that information that may affect the restriction speed of the train is generated and the automatic operation speed profile calculator 200 calculates a position-speed profile with which the train is automatically operated according to the calculated restrictive speed profile.

Further, when the calculated position-speed profile is transmitted to the on-board system 150 or the on-board system 150 requests a target speed according to the position of the train, the target speed is searched for from the position-speed profile and transmitted to the on-board system 150.

In this case, while it is possible to minimize the calculation load in the on-board system 150, there is a shortcoming in that the amount of data transmission is large and the calculation load in the ground system 100 is heavy.

However, even when the ground system 100 calculates the position-speed profile with respect to several trains, the possibility that the restrictive speed profile is simultaneously updated in the several trains is low (profile update does not continue to occur during the train runs), so that the calculation ability is not needed much in the ground system 100, compared with the case of calculating the profile in the on-board system 150 (that is, when n trains are treated on the ground, n times of calculation ability is not needed).

Further, in order to control running of the train according to the present disclosure, a target speed with respect to current position of the train each control period is needed (automatic operation position-speed profile). This information can also be stored as an expression or a list of position-speed pair.

When an expression of the time-speed profile in the automatic operation is obtained by applying a basic pattern with respect to each time section as shown in FIG. 11, it is possible to obtain an expression of the automatic operation time-position profile using the expression of the time-speed profile. Then, it is possible to calculate a value of the target speed in the time-speed profile with respect to current position of the train each control period using the expression (with the time as a parameter).

FIG. 12 shows a method in which a pattern of jerk profile is applied in each section and target speed values according to the position are sequentially obtained on the basis of the application result. This is a calculation method suggested in the operation described above, which utilizes an iterative calculation ability of computer (or microprocessor). In this method, position-target speed pairs are sequentially obtained in a specific time interval (fixed or variable) while it starts from a starting point of the restrictive speed profile and repeatedly proceeds to the next target point. When using this method, it is possible to obtain a list of a series of position-speed pairs with a specific time resolution from the starting point.

The train can draw target speed by searching for the list according to a current position each control period and control its output using the drawn target speed.

While the method described here can be regarded as a forward method in which the calculation is performed in the direction from a starting point to a destination point, a backward method may be used in which the same jerk profile pattern is used and the calculation is performed in the reverse direction.

Hereinbefore, while the present disclosure is described in detail with respect to a typical embodiment, one of ordinary skill in the art may recognize that various alterations, modifications, and variations that fall within the scope of the present disclosure may be possible with respect to the embodiment described above.

Therefore, it is intended that the scope of the present disclosure not be defined by the embodiments described above, but defined by following claims and their equivalence.

What is claimed is:

1. A speed control apparatus in an automatic train operation, comprising:
an automatic operation speed profile calculator that calculates a target speed at each position where a train is automatically operated using a restrictive speed profile inputted from a restrictive speed profile provider, and provides a position-speed profile with which the train is automatically operated;
a speed/position calculator that calculates current position and running speed of the train; a target speed searching unit that searches for a target speed at a current position of the train calculated by the speed/position calculator from a position-speed profile provided by the automatic operation speed profile calculator;
a subtractor that subtracts the target speed searched by the target speed searching unit from the running speed of the train calculated by the speed/position calculator and detects a speed error; and
a propulsion/brake calculator that generates propulsion or brake instruction of the train according to the speed error detected by the subtractor, wherein the automatic operation speed profile calculator extracts an acceleration target point to be reached by accelerating the train, a constant speed target point to be reached by running the train at a constant speed and a deceleration target point to be reached by decelerating the train from the restrictive speed profile, divides sections between a starting position, the acceleration target point, the constant speed target point and the deceleration target point of the train, and calculates a position-speed profile in each section.

2. The speed control apparatus of claim 1, wherein the restrictive speed profile includes information on a restrictive speed at which the train will run in each section.

3. The speed control apparatus of claim 1, wherein a calculation of the position-speed profile is performed in that a time-speed profile is calculated in each section, a time-position profile is calculated using the calculated time-speed profile and then a position-speed profile is calculated using the time-speed profile and the time-position profile.

4. The speed control apparatus of claim 1, further comprising a database to store the position-speed profile provided by the automatic operation speed profile calculator, wherein the target speed searching unit searches for a target speed from the database.

5. The speed control apparatus of claim 4, wherein the restrictive speed profile provider is installed in a ground system and wirelessly transmits the restrictive speed profile to an on-board system, and the automatic operation speed profile calculator is installed in an on-board system, calculates a position-speed profile using the restrictive speed profile that is wirelessly transmitted by the restrictive speed profile provider and stores the position-speed profile in the database.

6. The speed control apparatus of claim 4, wherein the restrictive speed profile provider and the automatic operation speed profile calculator are installed in the ground system, transmit the position-speed profile provided by the automatic operation speed profile calculator to the on-board system and store the profile in the database.

7. The speed control apparatus of claim 4, wherein the restrictive speed profile provider and the automatic operation speed profile calculator are installed in the on-board system.

8. A speed control method in an automatic train operation, comprising:
providing, by an automatic operation speed profile calculator, a position-speed profile that is a target speed at each position where a train is automatically operated using an restrictive speed profile inputted from a restrictive speed profile provider;
calculating a current position and a running speed of the train by a speed/position calculator;
searching for a target speed at the current position of the train from the position-speed profile by a target speed searching unit;
detecting a speed error by subtracting the searched target speed from the running speed of the train; and
generating a propulsion or brake instruction of the train according to the detected speed error.

9. The speed control method of claim 8, wherein providing, by an automatic operation speed profile calculator, a position-speed profile that is a target speed at each position where a train is automatically operated using an restrictive speed profile inputted from a restrictive speed profile provider includes:
extracting an acceleration target point to be reached by accelerating the train, a constant speed target point to be reached by running the train at a constant speed and a deceleration target point to be reached by decelerating the train from the restrictive speed profile;
dividing sections between a starting position, the extracted acceleration target point, the extracted constant speed target point and the extracted deceleration target point of the train; and
calculating a speed of the train to be run at each position of the train in each section divided and providing the position-speed profile.

10. The speed control method of claim 9, wherein providing, by an automatic operation speed profile calculator, a position-speed profile that is a target speed at each position where a train is automatically operated using an restrictive speed profile inputted from a restrictive speed profile provider includes:
calculating the time-speed profile in each section divided; calculating a time-position profile using the calculated time-speed profile; and
calculating a position-speed profile by detecting a speed of the train to be run at each position from the time-speed profile and the time-position profile, and providing the calculated position-speed profile.
